(19) United States
(12) Patent Application Publication
(10) Pub. No.: US 2002/0134955 A1
(43) Pub. Date: Sep. 26, 2002

(54) Remotely actuated pipeline valve and method

(76) Inventor: Greg Konwinski, Naperville, IL (US)

Correspondence Address: ORUM & ROTH, 53 W JACKSON BLVD, CHICAGO, IL, 60604-3606, US

(21) Appl. No.: 09/814,155

(22) Filed: Mar. 21, 2001

(51) Int. Cl. F16K 31/44; F16K 31/02

(52) U.S. Cl. 251/68; 251/129.04; 251/297

(57) ABSTRACT

The subject invention relates to a method and apparatus for closing off a live fluid line. This apparatus consists of a plunger which is held open by detents and a spring which biases the plunger closed against an opening in a live fluid pipeline. This apparatus is fed into a live fluid pipeline. The apparatus also contains a battery and a solenoid. In operation, when the fluid line leading to a building or home is to be closed, this may be accomplished by merely depressing a button on a transmitter which releases the spring and plunger from the detent stop in the open position, thereby closing the pathway from the main to the fluid outlet in the building or home. This apparatus and method therefore allow for the blocking and stopping of fluid to the house without excavation.

### BACKGROUND OF THE INVENTION

1. Field of the Invention

This invention concerns live fluid or gas pipelines used to carry fluid or gas, such as natural gas, from a main to an outlet for use, and a method and apparatus for automatically shutting off the same. This invention is used to remotely close a live fluid or gas pipeline without any need for excavation.

2. Description of the Related Art

In the past, when the need arose to close off a live fluid or gas pipeline, sometimes known in the industry as a service line, from the main, an operator was required to enter the building where the outlet was located in the form of a meter and to manipulate valves located on the meter so as to close the flow of fluid or gas in the pipeline. In other instances, an operator had to locate and possibly excavate the area located around a valve closure on a pipeline which carried live fluid or gas into a structure and close the pipeline at that valve point. This entailed location of the valve closure along the length of the pipeline, excavation at that location, location of the valve, and manipulation of the valve so as to close the pathway for the gas or fluid. This procedure is much more costly, time-consuming, and destructive to landscaping and other property than the present invention which consists of a remotely activated method and apparatus for closing a live fluid or gas pipeline without the need for excavation. In other cases, where a valve is inoperable or non-existent, an excavation of an area adjacent the desired cut-off part is necessary, to allow physical blockage of the flow path by penetration or separation of the pipeline.

### BRIEF SUMMARY OF THE INVENTION

The present invention functions as a remotely activated automatic live fluid or gas pipe closure apparatus and method. The present invention essentially consists of an apparatus which is attached to the downstream end of a new pipe which has been inserted into an old pipe leading to a gas or fluid main. The apparatus of the present invention is attached to a live fluid pipe replacement apparatus used to repair a ruptured pipe by inserting a new pipe into the ruptured pipe while preventing the flow of gas or fluid from the ruptured pipe without the need for any excavation or upstream valving or cutting off of the fluid or gas from the main. Once the plug which obstructs the opening or pathway in the live fluid pipeline replacement apparatus is removed, the apparatus of the present invention remains attached to the end of the new pipe. It remains attached in an open position so that gas or fluid may freely flow from the main through the present apparatus and continue through the new pipe.

The apparatus of the present invention consists of a housing having a first and a second end. At the first end is located a receiver for receiving transmitter signals from a transmitter located above ground controlled by an operator to close the pathway located within the housing of the present invention. Attached at one end to the receiver is a spring means, which is attached at its opposite end to a plunger. The plunger and spring are held in a compressed position by a detent mechanism. When the plunger is held by the detent mechanim, the spring is in a compressed position. Located toward the second end beyond the plunger and detent mechanism are a plurality of openings in the housing of the present invention through which fluid flows into the opening in the new pipe. At the second end of the present mechanism is an opening which cooperates with the plurality of openings in the apparatus of the present invention through which fluid may flow. When the mechanism of the present invention is inserted into a live fluid pipeline at the downstream-most end of the live fluid pipe insertion apparatus, it is inserted in an open position, that is, in a position wherein the spring is compressed and the plunger is held by the detent mechanism.

The apparatus of the present invention operates through the use of a transmitter above ground which sends signals to a receiver located at a first end of the apparatus of this invention. The receiver sends a signal to the spring to bias the plunger against the opening at the second end of the mechanism of this invention and which, concurrently, sends a signal to open the detent mechanism so as to allow the spring to act and close upon the opening located at the second end of the apparatus of the present invention. In this manner, the flow of fluid and gas is prevented from entering the new pipe and reaching the outlet located within the structure to which the flow of fluid or gas is intended to be stopped.

One object of the present invention is to provide a remotely actuated automatic means to interrupt the flow of fluid, in one embodiment natural gas, without the need for permanent upstream valving.

Another object of the present invention is to provide a remote and automatic method to interrupt the flow of fluid into a structure without the need for excavation.

Another object of the present invention is to remotely and automatically close a live fluid pipeline without the need to enter the structure in which the meter is attached at the downstream end of the live fluid or gas pipeline.

### BRIEF DESCRIPTION OF THE DRAWINGS

FIG. 1 is a cross-section of the old pipe showing the pipe renewal apparatus and the remote automated pipeline valve shut-off apparatus.

FIG. 2 is a cross-sectional view of the old pipe and the remote automated pipeline valve shut-off apparatus in the open position.

FIG. 3 is a cross-sectional view of the old pipe and the remote automated pipeline valve shut-off apparatus in the closed position.

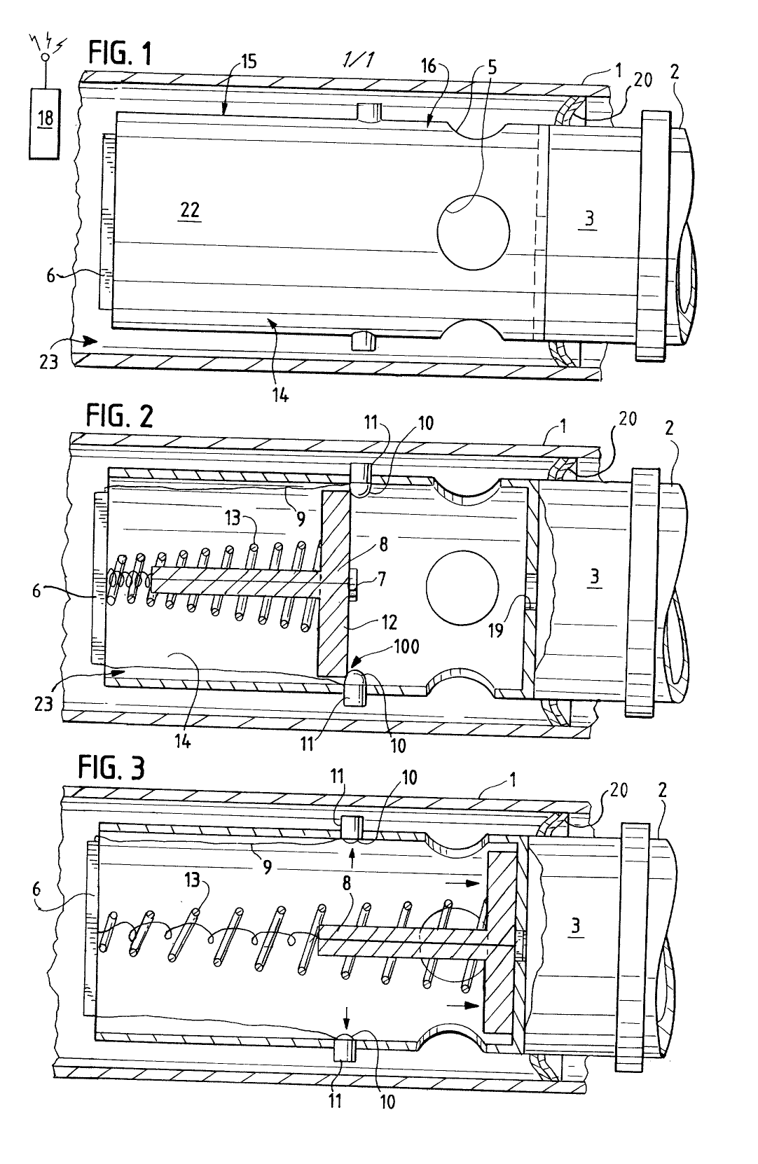

### DETAILED DESCRIPTION OF THE INVENTION

In the field of fluid and gas pipelines, the present invention provides a remote and automatic method and apparatus by which a live fluid, or in particular a natural gas pipeline, can be closed. This remote and automatic method and apparatus prevents the need to use other costly and destructive methods or apparatus. This apparatus can be used with existing pipes 1 by being inserted at the end of a new pipe 2 which has attached to it a nosecone 3 as part of a live fluid pipe replacement apparatus. At the end of the nosecone 3 there is a fin 20 or a plurality of fins so as to block the flow of fluid or gas from an upstream supply point to the outlet at the insertion point of the live fluid pipeline replacement apparatus. The remotely activated pipeline valve closure apparatus 14 can also be attached directly to the end of a new pipe 2 without the need for it to be attached to an intermediary nosecone 3. The remotely activated pipeline valve closure apparatus 14 consists of a housing 22 having a first 15 and a second end 16. The housing 22 has a receiver 6 at its first end 15 which receives a signal from a transmitter 18 operated by an operator above ground. The housing 22 includes a longitudinal bore 23 which, at the second end 16 of the housing 22, has an orifice plate sealing said housing, said orifice plate having opening 19 to the housing 22. The body of the housing 22 has a plurality of passageways 5 which cooperate with the bore 23. Located within the bore 23 of the housing 22 is a spring 13 which is attached at one end of the spring to the receiver 6 and at the opposite end of the spring to a plunger 12. At the opposite end of the plunger 12 which is attached to the spring 13 there is a power source or battery 7. The plunger 12 is held in an open position as shown in FIG. 2 by a detent mechanism 10 located along the interior sides of the bore 23 of the housing 22. One or more solenoids 11 are coupled with the plurality of detent mechanisms 10 on the opposite face of the detent mechanism 10 which is in contact with the plunger 12. The detent mechanism 10 operates to maintain the plunger 12 in an open position and to hold the plunger 12 in the open position against the bias of the spring 13. A conducting wire 8 travels from the battery 7 through the plunger 12 and is encoiled along the spring 13 and finally attached to the receiver 6 in order to power the receiver 6. A plurality of solenoid wires 9 run from the receiver 6 to the solenoids 11 to carry the signal received from the transmitter 18 to the solenoids 11 to withdraw the detent mechanism 10. When the detent mechanism 10 is withdrawn, the plunger 12 is released from its seat 10 and moved into the closed position as shown in FIG. 3. In the open position, the plunger 12 is located closer to the first end 15 of the remotely activated pipeline valve closure apparatus 14 and anterior to the plurality of passageways 5 in the housing 22.

As shown in FIG. 3, the plunger 12 is shown in the closed position. In the closed position, the plunger 12 is biased against the opening 19 cooperating with the opening in the nosecone 3 or the new pipe 2, whichever may be present. The plunger 12 is biased against the opening 19 cooperating with the opening in either the nosecone 3 or the new pipe 2 through the force of the spring 13. The detent mechanisms 10 are withdrawn from the surface of the plunger 12 in such a manner so that they no longer form a seat 100 for the plunger 12 halting its forward progress against the opening 19 cooperating with the opening in the nosecone 3 or the new pipe 2. In this manner, the plunger 12 is located posterior to the plurality of passageways 5 located in the housing 22.

In operation, the remotely activated pipeline valve closure apparatus 14 functions by the transmitter 18 transmitting a signal which is received by the receiver 6 located on the first end 15 of the remotely activated pipeline valve closure apparatus 14. The receiver 6 is powered by a battery 7. A plurality of solenoid wires 9 carry the signal received from transmitter from the receiver 6 to the solenoids 11. The solenoids 11 act upon the detent mechanisms 10 so that the plunger 12 is unseated and the spring 13 biases the plunger 12 against the opening 19. In this position, fluid or gas is prevented from flowing from downstream at the main upstream to the live fluid or gas outlet. In order to reopen the pathway so that fluid or gas may travel from the main, through the remotely activated pipeline valve closure apparatus 14, and through either a nosecone 3 attached to a new pipe 2 or through the new pipe 2 alone, the plunger 12 must be manually reset by applying a force against the face of the plunger 12 located opposite the spring 13 and pushing it so that it is once again seated with the spring in a compressed position and behind the detent mechanisms 10. When the battery 7 is consumed, the battery 7 may be replaced by manually inserting an apparatus having at one end a magnet 20 or other means by which to remove the battery 7. The consumed battery 7 is then withdrawn through the nosecone 3 and/or the new pipe 2 and removed from the remotely activated pipeline valve closure apparatus 14. A new battery 7 is inserted into the new pipe 2 and/or the nosecone 3 and is seated in the same location where the consumed battery 7 was located.

In one embodiment, the detent mechanism 10 may be a ball detent. In another embodiment, the detent mechanism 10 may be square-shaped, cylindrically-shaped, or a variety of other shapes.

In one embodiment, the plurality of passageway 5 may be circular-shaped. In subsequent embodiments, the passageway 5 may be square-shaped, cylindrically-shaped, or a variety of other shapes.

It will be understood that the invention may be embodied in other specific forms without departing from the spirit or central characteristics thereof. The present embodiments, therefore, are to be considered in all respects as illustrative and not restrictive, and the invention is not to be limited to the details given herein.

1. A closure apparatus for sealing a leaking pipeline comprising:
a hollow, tubular housing having a first end, a second end adapted for connection to a segment of new pipe, and a plurality of circumferentially spaced passageways disposed between said ends, said passageways fluidly communicating an outside of said housing with an inside of said housing, wherein said second end is sealed by a plate which includes a centralized orifice therein;
means for holding and sealing said housing within a leaking segment of pipeline, said means attached circumferentially about said housing between said passageways and said first end;
a radio signal receiver disposed within said housing at said first end, said receiver for receiving a remotely transmitted radio control signal;
an automated, radio-controlled valve assembly disposed within said housing for controlling a fluid flow through said orifice, said valve assembly comprising:
(i) a valve comprised of a plunger for removable engagement against said plate so as to seal said orifice;
(ii) a biasing spring having a pair of ends, one end connected to said receiver and the other end connected to said valve plunger; and
(iii) detent means for opening and closing said valve, wherein when said valve is in an open position, said passageways and said orifice are in fluid communication, wherein when said valve is closed, said plunger covers said orifice and prevents fluid communication between said passageways and orifice.

2. The apparatus of claim 1, further including a radio transmitter, which said transmitter is remotely disposed from said valve assembly and which controls the opening and closing of said valve.

3. The apparatus of claim 1, wherein said means for holding and sealing comprises a flexible plurality of fins which form a labyrinth seal between said housing and a leaking pipeline.

4. The apparatus of claim 1, wherein said detent means comprises at least two solenoid valves coupled to respective physical stops, said stops radially movable into said interior of said housing.

5. The apparatus of claim 4, wherein said detent means are disposed in said housing between said passageways and said first end.

6. The apparatus of claim 5, wherein said physical stops contact against a face of said plunger, thereby holding and preventing said plunger from being biased by said spring in a direction towards said orifice, said held position corresponding to said open position of said valve.
